(19) United States
(12) Patent Application Publication
(10) Pub. No.: US 2008/0210125 A1
(43) Pub. Date: Sep. 4, 2008

(54) Stable cement composition for orthopaedic and dental use

(75) Inventors: Leif Hermansson, Uppsala (SE); Hakan Engqvist, Knivsta (SE)

Correspondence Address: YOUNG & THOMPSON, 209 Madison Street, Suite 500, ALEXANDRIA, VA, 22314, US

(73) Assignee: DOXA AB, UPPSALA (SE)

(21) Appl. No.: 11/712,462

(22) Filed: Mar. 1, 2007

(51) Int. Cl. C04B 35/00; C09K 3/00

(52) U.S. Cl. 106/35; 252/183.13; 501/153

(57) ABSTRACT

The present invention relates to ceramic precursor compositions and chemically bonded ceramic (CBC) materials, especially Ca-based, and composite biomaterials suitable for orthopaedic and dental applications with improved setting and curing properties resulting in stable close contact between biomaterial and bone tissue. The present invention also relates to a method of manufacturing said cured material, a bioelement and carrier material for drug delivery made by said cured material, a kit comprising the ceramic precursor powder and hydration liquid, as well as the use of said ceramic precursor powder and hydration liquid, or said cured material, for orthopaedic and dental applications.

### FIELD OF THE INVENTION

The present invention relates to ceramic precursor compositions and chemically bonded ceramic (CBC) materials, especially calcium aluminate-based, and composite biomaterials suitable for orthopaedic applications and dental applications.

### BACKGROUND

Injectable non-resorbable biomaterials for orthopaedic applications, especially in the spine or in hip replacements, and dental applications are based upon resin containing formulations, e.g. BIS-GMA or MMA as described in [G. Lewis, Injectable bone cements for use in Vertebroplasty and Kyphoplasty: state-of-the-art review, J Biomed Mater Res Part B: Appl Biomater, 76 B: 456-468, 2006]. The injected material is intended to stabilise and/or help augment/reinforce the bone void defect. For increased visibility under the injection and after hardening, the biomaterial needs to have a high radio-opacity. This is achieved by the use of radio-opaque filler particles. A resin-based material for the use in orthopaedics is normally a combination of a resin (monomer and accelerator) and one or more radio-opaque fillers. The components are mixed together into a paste and injected into the bone void defect, where it hardens through a polymerisation process and a solid body is formed.

For an improved stabilisation or augmentation of the bone void defect it is important to obtain a close contact with the bone tissue surrounding the defect. The presently used resin-based materials shrink during hardening as described in [F. N. K. Kwong, R. A. Power, A comparison of the shrinkage of commercial bone cements when mixed under vacuum, J Bone Joint Surg 2006; 88-B: 120-2]. The amount of shrinkage is reported to be more than 3 percent of the initial volume. The injected biomaterial does not have an optimal contact to the bone void defect, resulting in non-optimal stabilisation or augmentation of the defect. The hydrophobic nature of the resin-based biomaterials also results in less contact with the hydrophilic bone tissue.

General aspects of using CBC materials based on Ca-aluminates related to manufacturing, dimensional stability and mechanical strength in dental and orthopaedic applications have earlier been described in U.S. Pat. No. 6,969,424 B2, WO 2004 37215, WO 2004 58124 and WO 2003 55 450.

It is desired to find a bone replacement material that exhibits a high degree of contact with bone tissue even after hardening of the material. Said material should also provide stability, exhibit a high radio-opacity and be applicable in orthopaedic, as well as dental applications, in particular vertebroplasty and endodontics, respectively.

### BRIEF DESCRIPTION OF THE INVENTION

The present invention relates to a bone replacement material that possesses all of the above-mentioned properties, and which may suitably be used in orthopaedic applications, such as vertebroplasty, and dental applications, such as endodontics (orthograde and retrograde fillings).

The present invention relates in particular to a biomaterial that exhibits no shrinkage during setting and curing, but a slight expansion. This is property, in combination with the hydrophilic nature of the material (due to the ability to bind water), yields a material that during curing forms a hardened chemically bonded material in close contact with a bone or body tissue (hereinafter only the term bone tissue will be used, even if the same contact will also be achieved with other body tissues), i.e. a gap-free contact. If inserted or injected into a cavity or bone void, this close contact with the bone results in a higher stability and strength of the bone void compared to that of resin-based systems.

The above-mentioned advantageous properties are achieved by a ceramic system comprising a hydraulic ceramic precursor powder which is hydrated using a specific hydration liquid that together form said cured ceramic material exhibiting increased dimensional stability during hardening. The ceramic precursor powder may comprise additives (a high density additive) imparting high radio-opacity in order to improve the X-ray visibility for the user during injection.

The present invention also relates to a method of manufacturing said cured material, bioelements, implant, or a carrier material based on said precursor powder or said cured material, a kit comprising the ceramic precursor powder and hydration liquid, as well as the use of said ceramic precursor powder and hydration liquid, or said cured material, for orthopaedic and dental applications.

### DETAILED DESCRIPTION OF THE INVENTION

The inventors have surprisingly found that by using calcium aluminate in combination with micro-silica (and may also comprise a high density additive for radio-opacity) mixed with a hydration liquid containing water, methyl cellulose, polycarboxylic compounds (i.e. polymeric compounds based on polycarboxylic acid) with a molecule weight in the interval 10,000-50,000 and lithium chloride the above-mentioned properties may be obtained.

The precursor powder according to the invention comprises in a basic embodiment:
Calcium aluminate as hydraulic precursor
Micro-silica as precursor additive

Said precursor powder are mixed with the hydration liquid according to the invention, which comprises:

mixed with, LiCl and
water
methyl cellulose, and
polycarboxylic compound

More specifically, the components of the precursor powder have the following characteristics:

### Calcium Aluminate

The calcium aluminate may have a grain size of below 40 micrometer, preferably below 20 micrometer, and more preferably below 15 micrometer. The grain size is determined as d99 (99%<cited value) using laser diffraction and calculated from the volume distribution, i.e. 1% of the powder may be of greater grain size.

The calcium aluminate is in glass phase and is to more than 50 atomic % comprised of CaO(Al₂O₃), preferably to more than 90%, and to less than 50 atomic % comprised of one or more of the phases (CaO)₁₂(Al₂O₃)₇, (CaO)₃Al₂O₃, CaO(Al₂O₃)₂, CaO(Al₂O₃)₆, and CaO(Al₂O₃) glass phase. The calcium aluminate constitutes 40-70 wt-%, preferably 57-63 wt-%, of the total amount of precursor powder. The calcium aluminate is the reactive phase (binder phase).

### Micro-Silica

The micro-silica (SiO₂) may have a grain size of below 30, preferably below 20 nm. The micro-silica is added in an amount of 0.5-5 wt-%, preferably 0.7-1.3 wt-%, of the total amount of the precursor powder.

### Zirconium Dioxide

Zirconium dioxide may be added as an inert precursor additive for increased radio-opacity. The zirconium dioxide (ZrO2) may have a grain size of below 20 micrometer, preferably below 10 micrometer, as determined as d99 (99%<cited value) using laser diffraction. The zirconium dioxide is added to achieve extra radio-opacity and is considered as a non-reacting, inert phase. The ZrO₂ is added in an amount of 20-50 wt-%, preferably 38-42 wt-%, of the total amount of the precursor powder.

If radio-opacity is not a desired property of the material, the zirconium dioxide may be replaced by or mixed with another inert phase of the same grains size and amount.

### Optional Additives

### Calcium Silicate

Calcium silicate may also be added to the precursor powder as an additional hydrating phase (also a reactive phase), in the form of C₃S or C₂S or combinations thereof, in the amount of below 10 wt-%. of the total amount of the precursor powder. The grain size should be below 40 micrometer, preferably below 20 micrometer. The calcium silicate also helps controlling the expansion of the material.

More specifically, the components of the hydration liquid have the following characteristics:

### Water

90-95 wt-% preferably 92-94 wt-% of the hydration liquid is constituted by water.

### Polycarboxylic Compound

The polycarboxylic compound may have a molecular weight within the interval 10000-50000, and constitutes 3-5 wt-%, preferably 3.7-4.3 wt-% of the hydration liquid. The compound is added to control the viscosity of the paste.

### Methyl Cellulose

The methyl cellulose constitutes 1-5 wt-% of the hydration liquid, preferably 2.5-3.5 wt-%. The compound is added to control viscosity and cohesion of a paste.

### Lithium Chloride

Lithium chloride (LiCl) constitutes 0.05-0.4 wt-% of the hydration liquid. LiCl is added to control the setting time.

When mixed, the precursor powder and the hydration liquid may form a paste or a slurry, depending on the water-to-cement (liquid-to-powder) ratio. The powder-to-liquid ratio should be kept within 3-6, preferably 4-4.5. For orthopaedic applications, where injectability is required, the higher ratios are applicable. The lower w/c ratios are used primarily for dental applications, such as permanent restorative fillings. For the higher w/c ratio, a higher zirconium dioxide content and the rheological additives may be required.

When said compositions and w/c ratios are correctly chosen, the Ca-aluminate precursor yields setting and curing reactions suitable both for orthopaedic and dental applications. This includes handling aspects and the establishment of an improved contact zone between the cured biomaterial and the bone tissue. The improved contact zone between the cured material and the bone tissue (see Example 2), is not just related to the dimension stability obtained by the said systems, but also to the hydrophilic nature of the precursor material used in the present application, and the reaction mechanisms which involve a specific phenomenon suitable for achieving close contacts, even gap free contacts between the cured material and the bone tissue.

This is related to the cement reaction used in the present invention, involving dissolution of the precursor cement phases and repeated precipitation in voids and upon bone tissue walls. This means that no shrinkage occurs and no extra pressure or contact forces are necessary for establishment of close contacts between the biomaterial and the bone tissue wall. The precipitated phases, i.e. hydrates, have been found to be of nano-size. This contributes to an optimised closure of gaps. Thus the hardening process must be controlled with regard to the type of reaction mechanism involved, reaction rate, setting, gelling and hydration and the resulting crystal size of precipitates, i.e. when and how the hydrates are formed.

The present application thus discloses the requirements for and the solution to two of the most important aspects of injectable biomaterials, namely a reduction of both the movement between the biomaterial and bone tissue (dimensional stability) during curing, and a reduction of the pressure or tension between the biomaterial and the bone tissue (low compression), i.e. establishment of stable contact between injected biomaterial and the surrounding bone tissue.

The material when injected into a cavity, creates a gap-free contact with the boundries of said cavity by exhibiting a linear expansion of 0-0.5 linear percent and/or a total expansion pressure of 0-4 MPa while curing (measured in a closed cavity by a photo technique based on Newton rings).

Complementary aspects with regard to injectability is presented in a separate application, filed Mar. 1, 2007 as patent application Ser. No. ______ .

### EXAMPLE 1

Compositions A to E as shown in Table 1 were used to evaluate the dimensional expansion during setting and curing. As a reference material E, a commercial PMMA material for vertebroplasty was included in the test. The hydration liquid had in all tests with Ca-aluminate the following composition:
Water=92.5 wt-%,
Polycarboxylic compound=4.2 wt-%, molecular weight 30000,
Methyl cellulose 3.1 wt-%, and
LiCl 0.2 wt-%.

The micro silica was kept constant at 1.5 wt-%. ZrO₂ was added to improve the radio-opacity.

TABLE 1
Chemical composition of the Ca-aluminate materials tested

| | CaO(Al₂O₃) | ZrO₂ | Ca-silicate | Hydration liquid |
|---|---|---|---|---|
| Sample | Weight-% | Weight-% | Weight-% | with |
| A | 75 (too high) | 20 | 3.5 | w/c ratio = 0.33 |
| B | 60 | 35 | 3.5 | w/c ratio = 0.45 |
| C | 55 | 40 | 3.5 | w/c ratio = 0.45 |
| D | 35 (too low) | 55 | 8.5 | w/c ratio = 0.62 |
| | | (too high) | | |
| E = PMMA | | | | |
| Ref. matrl. | | | | |

NB.
Samples A and D represent compositions where one or more of the parameters are outside the intervals claimed in this application.

The materials according to Table 1 were evaluated with regard to dimensional stability using linear dimensional change and expansion/shrinkage stress (i.e. pressure exerted by the material on the cavity or adjacent tissues), and the results are presented in Table 2.

TABLE 2
Dimensional stability of the material tested

| | | Dimensional | | |
|---|---|---|---|---|
| | Dimensional | change - | Dimensional | Dimensional |
| | change - | Exerted | change - | change - Exerted |
| | in linear | pressure - | linear | pressure - |
| | percent, after | as pressure in | percent, at 7 | as pressure in |
| Sample | 2 h | MPa, after 2 h | days | MPa, at 7 days |
| A | +0.2 | <2 | +1 | +6 |
| B | +0.1 | <2 | +0.4 | +3.5 |
| C | +0.1 | <2 | +0.3 | +2.9 |
| D | 0 | <2 | −0.2 | <2 |
| E | −2 | −3 | −1.7 | −2.1 |

Sample A (outside a desired interval) exhibits a too high expansion and related pressure, and Sample D (also outside the desired interval) exhibits a shrinkage.

The table indicates (discloses) the boundaries for optimal contact pressure and reduced dimensional change, two important aspects of establishment of stable and tight contact between a biomaterial and bone tissue.

### EXAMPLE 2

Material C in Example 1 was evaluated with regard to the microstructure obtained at the contact zone between the material and bone tissue. The precipitated hydrate size was determined by use of high resolution FIB-TEM technique (see Engqvist et al, Biomaterials 25 (2004) p 2781-2787). It was shown that the size of precipitates was of nano-size, i.e. 20-50 nm, and that precipitation upon the biological bone tissue occurs.

1. A hydraulic ceramic precursor powder for orthopaedic and dental applications, comprising:
40-70 wt-% of calcium aluminate,
20-50 wt-% of zirconium oxide and/or another inert phase,
0.5-5 wt-% of micro-silica,
wherein said components are based on the total amount of the precursor powder, and wherein the calcium aluminate is constituted by more than 50 atomic% of CaOAl₂O₃ and less than 50 atomic% of one or more of the phases (CaO)₁₂(Al₂O₃)₇, (CaO)₃Al₂O₃, CaO(Al₂O₃)₂, CaO(Al₂O₃)₆, and CaO—Al₂O₃ glass phase.

2. The precursor powder according to claim 1, wherein the powder comprises:
57-63 wt-% of calcium aluminate,
38-42 wt-% of zirconium oxide and/or another inert phase,
0.7-1.3 wt-% of micro-silica,
wherein said components are based on the total amount of the precursor powder, and wherein the calcium aluminate is constituted by more than 90 atomic% CaOAl₂O₃ and less than 10 atomic% of one or more of the phases (CaO)₂(Al₂O₃)₇, (CaO)₃Al₂O₃, CaO(Al₂O₃)₂, CaO(Al₂O₃)₆, and CaO—Al₂O₃ glass phase.

3. The precursor powder according to claim 2, wherein the calcium aluminate has a grain size of below 40 μm, the zirconium oxide a grain size of below 20 μm, and the micro-silica a grain size of below 30 nm.

4. The precursor powder according to claim 3, wherein the calcium aluminate has a grain size of below 15 μm, the zirconium oxide a grain size of below 10 μm, and the micro-silica a grain size of below 20 nm.

5. The precursor powder according to claim 4, wherein the powder further comprises calcium silicate, in the form of C₃S or C₂S, or combinations thereof, in an amount of less than 10 wt-% based on the total amount of the precursor powder.

6. The precursor powder according to claim 5, wherein the calcium silicate has a grain size of below 40 μm.

7. The precursor powder according to claim 6, wherein the calcium silicate has a grain size of below 20 μm.

8. A hydration liquid for hydrating the precursor powder defined claim 1, comprising:
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein said amounts are based on the total weight of the hydration liquid.

9. The hydration liquid according to claim 8, wherein the hydration liquid comprises:
92-94 wt-% water,
3.7-4.3 wt-% of a polycarboxylic compound having a molecular weight of 10000-50000,
2.5-3.5 wt-% of methyl cellulose, and
0.05-0.4 wt-% of LiCl,
wherein said amounts are based on the total weight of the hydration liquid.

10. A method of manufacturing an injectable chemically bonded ceramic material, comprising the step of mixing the precursor powder defined in claim 1 with a hydration liquid comprising
90-95 wt-% of water,
3-5 wt-% of a polycarboxylic compound, and having a molecular weight of 10000-50000,
1-5 wt-% of methyl cellulose, and
0-05-0.4 wt-% of LiCl,
wherein said amounts are based on the total weight of the hydration liquid in a liquid-to-powder ratio of 3-6, such that a paste is formed that eventually hardens into a chemically bonded material.

11. The method according to claim 10, wherein the initial liquid-to-powder ratio in the paste is 4-4.5.

12. A chemically bonded ceramic material for orthopaedic and dental applications, wherein said material is based on a paste formed from mixing the precursor powder defined in claim 1 and a hydration liquid in a liquid-to-powder ratio of 3-6, wherein the hydration liquid comprises:
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein said amounts are based on a total weight of the hydration liquid.

13. The material according to claim 12, wherein said material, when injected into a cavity, creates a gap-free contact with the boundries of said cavity by exhibiting a total dimensional change of 0-0.5 linear percent and/or a total expansion pressure below 4 MPa during setting and curing.

14. A bioelement or implant for orthopaedic and dental applications, wherein said element is based on the precursor powder defined in claim 1 and a hydration liquid, wherein the hydration liquid comprises:
90-95 wt-% of water,
3-5 wt-% of a polycarboxylic compound, and having a molecular weight of 10000-50000,
1-5wt-% of methyl cellulose, and
0.05-0.4 wt-% of LiCl,
wherein said amounts are based on a total weight of the hydration liquid.

15. A carrier material for drug delivery, wherein said element is based on the precursor powder defined in claim 1 and a hydration liquid, wherein the hydration liquid comprises:
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein said amounts are based on a total weight of the hydration liquid.

16. A kit for manufacturing a chemically bonded ceramic material, comprising a container wherein the precursor powder defined in claim 1 and a hydration liquid comprising
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein said amounts are based on the total weight of the hydration liquid are stored separately.

17. (canceled)

18. A method of manufacturing a bioelement or implant for orthopaedic and dental applications, or a carrier material suitable for drug delivery, comprising the step of mixing the precursor powder defined in claim 1 with a hydration liquid comprising
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein a paste is formed that eventually hardens into a chemically bonded material.

19. A chemically bonded ceramic material for orthopaedic and dental applications, wherein said material is based on a paste formed from mixing a precursor powder and a hydration liquid in a liquid-to-powder ratio of 3-6, wherein the precursor powder comprises:
40-70 wt-% of calcium aluminate,
20-50 wt-% of zirconium oxide and/or another inert phase, and
0.5-5 wt-% of micro-silica,
wherein said components are based on a total amount of the precursor powder, and wherein the calcium aluminate is constituted by more than 50 atomic% of CaOAl₂O₃ and less than 50 atomic% of one or more of the phases (CaO)₁₂(Al₂₃)₇, (CaO)₃Al₂O₃, CaO (Al₂O₃)₂, CaO(Al₂O₃)₆, or CaO—Al₂O₃ glass phase
wherein the hydration liquid comprises:
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein said amounts are based on a total weight of the hydration liquid.

20. A bioelement or implant for orthopaedic and dental applications, wherein said element is based on a precursor powder and a hydration liquid,
wherein the precursor powder comprises:
40-70 wt-% of calcium aluminate,
20-50 wt-% of zirconium oxide and/or another inert phase, and
0.5-5 wt-% of micro-silica,
wherein said components are based on a total amount of the precursor powder, and wherein the calcium aluminate is constituted by more than 50 atomic% of CaOAl₂O₃ and less than 50 atomic% of one or more of the phases (CaO)₁₂(Al₂O₃)_{7,} (CaO)₃Al₂O₃, CaO (Al₂O₃)₂, CaO (Al₂O₃)₆, or CaO—Al₂O₃ glass phase
wherein the hydration liquid comprises:
90-95 wt-% of water,
3-5 wt-% of a polycarboxylic compound, and having a molecular weight of 10000-50000,
1-5 wt-% of methyl cellulose, and
0.05-0.4 wt-% of LiCl,
wherein said amounts are based on a total weight of the hydration liquid.
